(19) United States
(12) Patent Application Publication
(10) Pub. No.: US 2025/0238434 A1
(43) Pub. Date: Jul. 24, 2025

(54) STORAGE SYSTEM MANAGEMENT DEVICE

(71) Applicant: ELECTRONICS AND TELECOMMUNICATIONS RESEARCH INSTITUTE, Daejeon (KR)

(72) Inventors: Jiwoo HAN, Daejeon (KR); Hee Sun WON, Daejeon (KR)

(21) Appl. No.: 18/938,427

(22) Filed: Nov. 6, 2024

(30) Foreign Application Priority Data
Jan. 18, 2024 (KR) 10-2024-0008224
Jun. 14, 2024 (KR) 10-2024-0077674

(51) Int. Cl. G06F 16/25; G06F 16/21; G06F 16/28

(52) U.S. Cl. CPC G06F 16/258; G06F 16/214; G06F 16/284

(57) ABSTRACT

Disclosed is a storage system management device, which includes a plurality of storage systems that store data in different types, a profile manager that manages first schema information including a structure of first data, an expression method, and a definition of relationships between data in the plurality of storage systems and manages first schema mapping information including mapping information associated with correlations between a plurality of pieces of schema information of the first data, a metadatabase that stores the first schema information and the first schema mapping information, and a data converter that performs an operation of accessing the first data in the plurality of storage systems, and the storage system management device manages schema information and schema mapping information associated with the data of the plurality of storage systems.

### CROSS-REFERENCE TO RELATED APPLICATIONS

This application claims priority under 35 U.S.C. § 119 to Korean Patent Application Nos. 10-2024-0008224 filed on Jan. 18, 2024, and 10-2024-0077674 filed on Jun. 14, 2024, in the Korean Intellectual Property Office, the disclosures of which are incorporated by reference herein in their entireties.

### BACKGROUND

### 1. Field of the Invention

Embodiments of the present disclosure described herein relate to management and collection of data, and more particularly, relate to a storage system management device.

### 2. Description of Related Art

Recently, with the development of IT technology, a large amount of data is being produced and consumed. Accordingly, companies are recognizing the need for data management systems to store and manage a large amount of data and are building data warehouses or DataLakes. The data warehouses require huge investment in cost and time due to the vast amount and complexity of data. Accordingly, there is a growing trend of companies using the DataLakes that may efficiently process various types of data.

The DataLakes store all types of data in various types of storage systems and then make the stored data available in the necessary format when needed. However, The DataLakes have difficulties in maintaining consistency and quality of data schemas as various types of storage systems are used. Ensuring smooth interoperability between various storage systems within the DataLakes is a significant challenge.

### SUMMARY

Embodiments of the present disclosure provide a device that ensures seamless interoperability between various storage systems within a DataLake.

According to an embodiment of the present disclosure, a storage system management device includes a plurality of storage systems that store data in different types, a profile manager that manages first schema information including a structure of first data, an expression method, and a definition of relationships between data in the plurality of storage systems and manages first schema mapping information including mapping information associated with correlations between a plurality of pieces of schema information of the first data, a metadatabase that stores the first schema information and the first schema mapping information, and a data converter that performs an operation of accessing the first data in the plurality of storage systems, and the storage system management device manages schema information and schema mapping information associated with the data of the plurality of storage systems.

According to an embodiment of the present disclosure, a storage system management method of a storage system management device including a plurality of storage systems, a profile manager, and a metadatabase, the method includes, first schema information includes a structure of first data, an expression method, and a definition of relationships between data in the plurality of storage systems, and first schema mapping information stored in the metadatabase includes mapping information associated with correlations between a plurality of pieces of schema information of the first data, receiving, by the profile manager, second schema information including a new structure of the first data, an expression method, and a definition of relationships between data, based on a profile generation request of the first data from a host, storing, by the profile manager, the second schema information in the metadatabase, and updating, by the profile manager, the first schema mapping information to include information associated with correlations between the first schema information and the second schema information.

### BRIEF DESCRIPTION OF THE DRAWINGS

The above and other objects and features of the present disclosure will become apparent by describing in detail embodiments thereof with reference to the accompanying drawings.

FIG. 1 is a diagram illustrating a DataLake management system, according to an embodiment of the present disclosure.

FIG. 2 is a diagram illustrating in detail each configuration of a DataLake management device, according to an embodiment of the present disclosure.

FIG. 3 is a flowchart illustrating a flow in which a DataLake management system generates new profile information associated with data in a DataLake.

FIG. 4 is a flowchart illustrating a flow in which a DataLake management system reads data in a DataLake.

### DETAILED DESCRIPTION

Hereinafter, embodiments of the present disclosure will be described in detail and clearly to such an extent that an ordinary one in the art easily implements the present disclosure.

The present disclosure is not limited to the embodiments disclosed below, but may be implemented in various forms and various modifications and changes may be applied. However, it is provided to complete the disclosure of the present disclosure through the description of the present embodiment, and to completely inform those skilled in the art of the scope of the disclosure to which the present disclosure belongs.

Although terms such as first, second, and third are used to describe various components in various embodiments of the present specification, these components should not be limited by these terms. These terms are only used to distinguish one component from another component. Embodiments described and illustrated herein also include complementary embodiments thereof.

In the specification, the singular forms include plural forms unless particularly mentioned. As used herein, “comprises 'and/or comprising” does not exclude the presence or addition of one or more other components, steps, operations and/or elements to the mentioned components, steps, operations and/or elements.

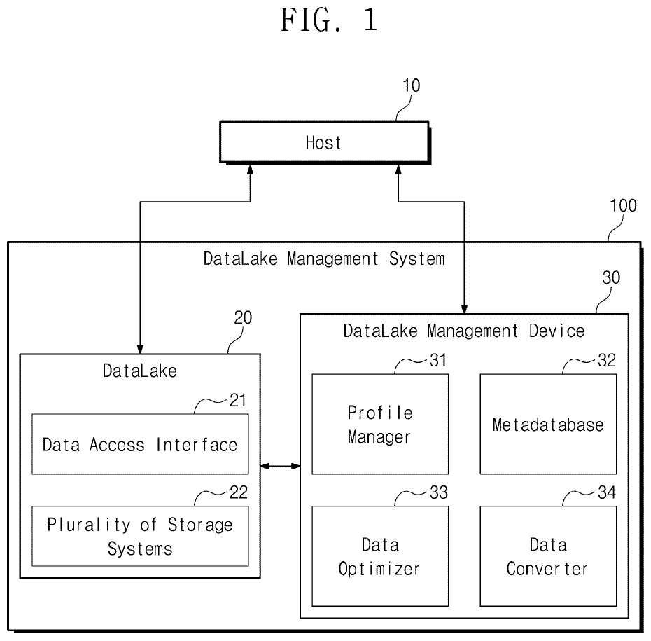

FIG. 1 is a diagram illustrating a DataLake management system 100, according to an embodiment of the present disclosure.

The DataLake management system 100 may include a DataLake 20 and a DataLake management device 30.

The DataLake management system 100 may be connected to an external host 10 and may exchange signals. For example, the host 10 may be configured to be connected to the DataLake 20 and the DataLake management device 30. For example, a user may access the DataLake management system 100 through the host 10.

The host 10 may be configured to provide a data access request to the DataLake 20. For example, the host 10 may be configured to provide a request to read, write, erase, etc. data to the DataLake 20. For example, the host 10 may be configured to provide new profile information associated with data in the DataLake 20. The profile information associated with data may include schema information.

The schema information may mean a description of the overall specification of the structure and constraints of a plurality of storage systems 22. For example, the schema information may include definitions of structures of data, expression methods, and relationships between data. For example, the schema may include constraints between data.

Since the technique according to an embodiment of the present disclosure stores the schema for data in a metadatabase 32 that is mapped to each schema rather than storing the schema in a data dictionary, various technical effects may be enjoyed accordingly.

The DataLake 20 may include a data access interface 21 and a plurality of storage systems 22.

The data access interface 21 may be configured to manage the plurality of storage systems 22 based on an access request from a host 10. The data access interface 21 may be configured to relay communications between the plurality of storage systems 22 and the host 10. For example, the data access interface 21 may be configured to provide a signal received from the host 10 to the DataLake management device 30. For example, the data access interface 21 may be configured to manage the plurality of storage systems 22 based on a signal received from the DataLake management device 30.

The data access interface 21 may be configured to verify the validity with respect to an access request from the host 10. For example, the data access interface 21 may determine whether the access request from the host 10 is in a correct format. For example, when there is an access request for first data in the plurality of storage systems 22 from the host 10, the data access interface 21 may be configured to verify the validity of the access request by determining whether the first data exists in the DataLake 20. For example, when there is a read request from the host 10, the data access interface 21 may be configured to determine whether there is access authority required for the read request. For example, when there is a request for generating new profile information for the first data from the host 10, the data access interface 21 may be configured to determine whether the host 10 has the access authority required for the profile generation request.

The plurality of storage systems 22 may include storage systems having various storage types. For example, the plurality of storage systems 22 may include row-based storage, column-based storage, object storage, memory-based storage, etc. The storage systems in the plurality of storage systems 22 may be configured to store and access data in different ways.

Although the present disclosure describes that the plurality of storage systems 22 are implemented in the form of the DataLake 20, the present disclosure is not limited thereto. For example, the plurality of storage systems 22 may utilize various types of data management systems such as a database, a data warehouse, and a data mart.

The DataLake management device 30 may include a profile manager 31, the metadatabase 32, a data optimizer 33, and a data converter 34.

The profile manager 31 may be configured to manage profile information associated with data in the DataLake 20. For example, the profile information may include schema information and schema mapping information. For example, data in the plurality of storage systems 22 may be configured to have different schema information, respectively.

The schema mapping information may include information describing correlations between different schema information. For example, first data in the plurality of storage systems 22 may include a plurality of pieces of field information. The profile manager 31 may be configured to map the plurality of pieces of field information of the first data to field information of the DataLake 20 to generate schema mapping information. For example, the first data may include ‘name’ field information. The profile manager 31 may be configured to map the ‘name’ field information of the first data to ‘user_name’ field information of the DataLake 20 to generate first schema mapping information.

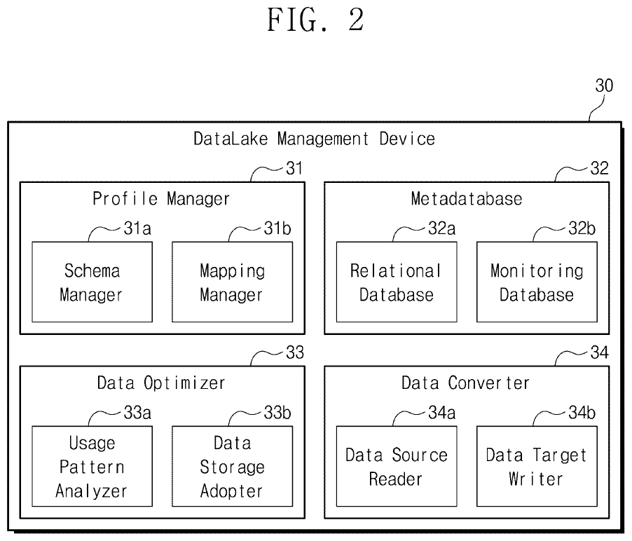

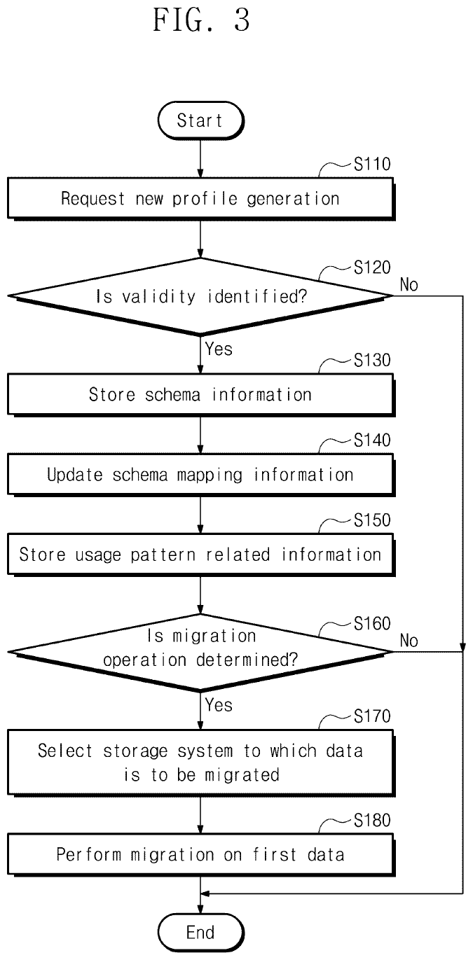

The profile manager 31 may be configured to generate new profile information with respect to data in the DataLake 20. For example, the profile manager 31 may be configured to receive new profile information from the host 10. For example, the profile manager 31 may be configured to receive new profile information through the data access interface 21. A detailed description of the profile manager 31 will be described later with reference to FIG. 2. A detailed description of generating the new profile information with respect to data in the DataLake 20 through the profile manager 31 will be described later with reference to FIG. 3.

The metadatabase 32 may store various information required for the DataLake management device 30 to manage the DataLake 20. For example, the metadatabase 32 may be configured to store schema information, schema mapping information, field information of the DataLake 20, type information of the plurality of storage systems 22, etc. For example, the metadatabase 32 may be configured to store usage pattern related information including an access time, an operation type, an operation frequency, etc. of the host 10 based on the access of the host 10. A detail description of the metadatabase 32 will be described later with reference to FIG. 2.

The data optimizer 33 may be configured to analyze the usage pattern related information and find a storage system to which data is to be migrated based on the analyzed result. A detail description of the data optimizer 33 finding a storage system to which data is to be migrated will be described later with reference to FIGS. 2 to 4.

The data converter 34 may be configured to allow the data management device to access data in the plurality of storage systems. For example, the data converter 34 may be configured to search for data in the plurality of storage systems 22. For example, the data converter 34 may be configured to search for first data in the plurality of storage systems based on a first data read request of the host 10 and to output the first data to the host 10.

The data converter 34 may be configured to receive a data migration signal from the data optimizer 33 and to migrate data between storage systems within the plurality of storage systems 22. A detail description of how the data converter 34 migrates data will be described later with reference to FIGS. 2 to 4.

With the above configuration, a user may define a schema with respect to a plurality of storage systems having various schemas in a customized manner. The user may manage a plurality of storage systems with a flexible schema structure by a user-defined schema.

In addition, the user may comprehensively perform mapping with respect to the custom defined schema. As comprehensive schema mapping is performed, the efficiency of data movement between a plurality of storage systems is improved.

Finally, dynamic adaptation to requirements between a plurality of storage systems is possible depending on user patterns. As comprehensive mapping is performed, movement between a plurality of storage systems becomes smooth, and data optimization strategies become easy by migrating data depending on usage patterns.

FIG. 2 is a diagram illustrating in detail each configuration of the DataLake management device 30, according to an embodiment of the present disclosure.

The profile manager 31 may include a schema manager 31a and a mapping manager 31b.

The schema manager 31a may be configured to manage schema information associated with the plurality of storage systems 22. For example, the schema manager 31a may be configured to provide schema information received from the host 10 to the metadatabase 32.

The mapping manager 31b may be configured to manage schema mapping information associated with the plurality of storage systems 22. For example, the mapping manager 31b may be configured to generate schema mapping information based on the schema information received from the host 10. The mapping manager 31b may be configured to provide the schema mapping information to the metadatabase 32. For example, the mapping manager 31b may be configured to generate the schema mapping information using the same schema mapping method with respect to all storage systems.

The mapping manager 31b may be configured to update the schema mapping information in response to a new schema information generation request from the host 10. For example, the first schema information may be schema information associated with the first data in the plurality of storage systems 22. The host 10 may provide the schema manager 31a with second schema information associated with the first data. The mapping manager 31b may be configured to update the schema mapping information with respect to the first schema information to include information associated with correlations between the first schema information and the second schema information.

The metadatabase 32 may include a relational database 32a and a monitoring database 32b.

The relational database 32a may be configured to store schema information received from the schema manager 31a. The relational database 32a may mean a space or data structure for storing profile information including meta information with respect to a specific schema.

The relational database 32a may be configured to store schema mapping information generated by the mapping manager 31b. For example, the relational database 32a may be configured to store the field information of the DataLake 20. The mapping manager 31b may be configured to map the field information of the DataLake 20 in the relational database 32a and the schema information received from the schema manager 31a to generate the schema mapping information.

The monitoring database 32b may be configured to store usage pattern related information. For example, the data access interface 21 may be configured to provide usage pattern related information to the monitoring database 32b based on an access request from the host 10. For example, the schema manager 31a may be configured to provide the usage pattern related information to the monitoring database 32b based on a schema generation request from the host 10. The monitoring database 32b may be configured to store the usage pattern related information and to provide the stored usage pattern related information to the data optimizer 33.

The monitoring database 32b may be configured to store type information of the plurality of storage systems 22. The type information of the storage systems may indicate performance, capacity, cost, etc. of the plurality of storage systems 22 within the plurality of storage systems 22. For example, when the data optimizer 33 determines that a migration operation is necessary, the monitoring database 32b may be configured to provide type information of the plurality of storage systems 22 to the data optimizer 33. For example, a data storage adopter 33b may be configured to select a storage system to which data is to be migrated based on type information of the plurality of storage systems 22.

The data optimizer 33 may include a usage pattern analyzer 33a and the data storage adopter 33b.

The usage pattern analyzer 33a may be configured to determine whether a migration operation is performed based on the usage pattern related information. The usage pattern analyzer 33a may be configured to determine whether a migration operation is performed by collecting or standardizing the usage pattern related information. For example, the usage pattern analyzer 33a may be configured to migrate to a suitable storage system based on an access time, an operation type, an operation frequency, etc. of the host 10. For example, the usage pattern analyzer 33a may be configured to determine whether a migration operation is performed based on the access frequency. For example, the usage pattern analyzer 33a may determine that a migration operation is necessary when data with a high access frequency is stored in a storage system with a relatively low access speed.

The usage pattern analyzer 33a may be configured to perform an analysis on the usage pattern related information whenever there is an access from the host 10. For example, the usage pattern analyzer 33a may be configured to detect that new data is stored in the monitoring database 32b. For example, the usage pattern analyzer 33a may be configured to perform an analysis on the usage pattern related information when new usage pattern related information is stored in the monitoring database 32b.

The data storage adopter 33b may be configured to select a storage system to which data is to be migrated based on a determination as to whether a migration operation is performed. For example, the data storage adopter 33b may be configured to select a storage system to which data is to be migrated in response to the usage pattern analyzer 33a determining that a migration operation is necessary.

For example, the data storage adopter 33b may be configured to receive schema mapping information from the relational database 32a. The data storage adopter 33b may be configured to select a storage system suitable for data migration based on the usage pattern analysis results and the schema mapping information.

For example, the data storage adopter 33b may be configured to receive type information of the plurality of storage systems 22 from the monitoring database 32b. The data storage adopter 33b may be configured to select a storage system to which data is to be migrated based on the type information of the plurality of storage systems 22 and the usage pattern analysis results. The data storage adopter 33b may be configured to provide information with respect to a storage system suitable for data migration to the data converter 34. For example, the data storage adopter 33b may be configured to select a storage system to which data is to be migrated based on the access frequency. For example, the data storage adopter 33b may allow data with a high access frequency to be migrated to a storage system with a relatively high access speed based on the type information of the plurality of storage systems 22.

The data converter 34 may include a data source reader 34a and a data target writer 34b.

The data source reader 34a may be configured to retrieve data from the plurality of storage systems 22. For example, the host 10 may provide a data read signal to the data access interface 21. The data source reader 34a may be configured to receive the data read signal from the data access interface 21 and to retrieve data in the plurality of storage systems 22.

The data target writer 34b may be configured to store data in the plurality of storage systems 22. For example, the host 10 may provide a data write signal to the data access interface 21. The data target writer 34b may be configured to receive the data write signal from the data access interface 21 and to store data in the plurality of storage systems 22.

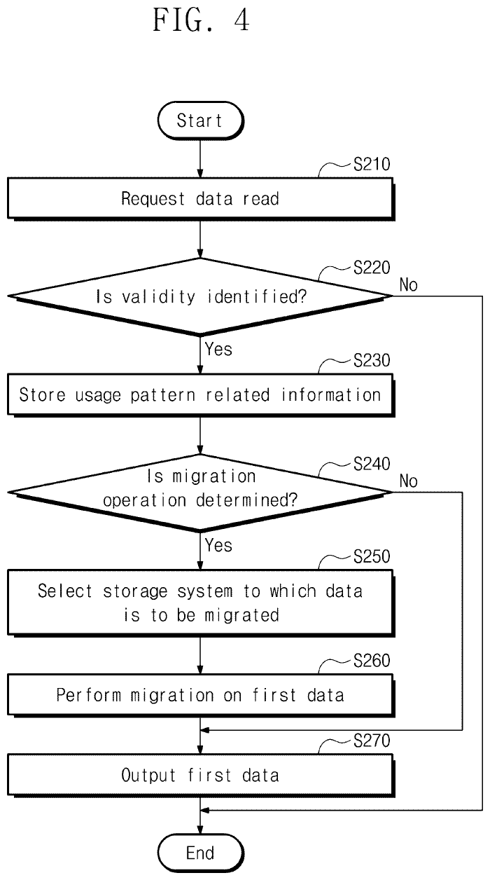

The data converter 34 may be configured to migrate data in response to the usage pattern analyzer 33a determining that a migration operation is necessary. For example, the data source reader 34a may be configured to retrieve the first data in the plurality of storage systems 22. The data target writer 34b may be configured to receive a storage system suitable for a migration from the data storage adopter 33b and to perform a migration operation on the first data. A detail description of the migration operation will be described later with reference to FIGS. 3 and 4.

FIG. 3 is a flowchart illustrating a flow in which the DataLake management system 100 generates new profile information associated with data in the DataLake 20. Hereinafter, the description will be given with reference to FIG. 1 and FIG. 3 together.

In operation S110, the host 10 may provide a profile generation request associated with the first data to the data access interface 21. For example, the first schema information may include a structure of the first data, an expression method, a definition of relationships between data. For example, the host 10 may provide new profile information associated with the first data to the profile manager 31 through the profile generation request. The new profile information may include second schema information.

In operation S120, the profile manager 31 may identify the validity of the profile generation request associated with the first data. For example, the profile manager 31 may determine whether the profile generation request for the first data has an access authority. For example, the profile manager 31 may determine whether a format of the first profile generation request is valid. For example, the profile manager 31 may determine whether the first data exists in the plurality of storage systems 22. When the request is valid, operation S130 may be performed. When the request is invalid, operation may be terminated.

In operation S130, the profile manager 31 may store the second schema information in the metadatabase 32.

In operation S140, the profile manager 31 may update the schema mapping information based on the first schema information and the second schema information. For example, the first schema mapping information may include mapping information associated with the correlation between a plurality of pieces of schema information of the first data. The profile manager 31 may update the first schema mapping information to include information associated with the correlation between the first schema information and the second schema information based on the second schema information.

In operation S150, the profile manager 31 may generate usage pattern related information and may store usage pattern related information in the metadatabase 32. For example, the first usage pattern related information may include the access time, the task type, and the task frequency of the host 10. For example, the profile manager 31 may generate second usage pattern related information including the time of the profile generation request of the first data, the task type, and the task frequency based on the profile generation request of the first data. The profile manager 31 may store the second usage pattern related information in the metadatabase 32.

In operation S160, the data optimizer 33 may analyze the usage pattern related information to determine whether a migration operation is performed. For example, the data optimizer 33 may analyze the first usage pattern related information and the second usage pattern related information to determine whether a migration operation with respect to the first data is performed. When the data optimizer 33 determines that a migration operation is necessary, operation S170 may be performed. When the data optimizer 33 determines that a migration operation is not necessary, operation may be terminated.

In operation S170, the data optimizer 33 may select a storage system to which the first data is to be migrated. For example, the first data may be stored in the first storage system. For example, the data optimizer 33 may select a second storage system to which the first data is to be migrated from among the plurality of storage systems 22.

In operation S180, the data converter 34 may perform migration on the first data. For example, the data converter 34 may receive the second storage system suitable for the migration of the first data from the data storage adopter 33b. The data converter 34 may search for the first data in the plurality of storage systems 22. For example, the data converter 34 may migrate the first data from the first storage system where the first data is stored to the second storage system. For example, after the migration is completed, the data converter 34 may delete the first data in the first storage system.

FIG. 4 is a flowchart illustrating a flow in which the DataLake management system 100 reads data in the DataLake 20. Hereinafter, the description will be given with reference to FIG. 1 and FIG. 4 together.

In operation S210, the host 10 may provide a read request associated with the first data to the data access interface 21.

In operation S220, the data access interface 21 may identify the validity of the read request associated with the first data. For example, the data access interface 21 may determine whether the read request associated with the first data has the access authority. For example, the data access interface 21 may determine whether the format of the read request associated with the first data is valid. For example, the data access interface 21 may determine whether the first data exists in the plurality of storage systems 22. When the request is valid, operation S230 may be performed. When the request is invalid, operation may be terminated.

In operation S230, the data access interface 21 may generate usage pattern related information and may store the usage pattern related information in the metadatabase 32. For example, the first usage pattern related information may include the access time, the task type, and the task frequency of the host 10. For example, the data access interface 21 may generate second usage pattern related information including the time of the first data read request, the task type, and the task frequency based on the first data read request. The data access interface 21 may store the second usage pattern related information in the metadatabase 32.

In operation S240, the data optimizer 33 may analyze the usage pattern related information to determine whether a migration operation is performed. For example, the data optimizer 33 may analyze the first usage pattern related information and the second usage pattern related information to determine whether a migration operation with respect to the first data is performed. When the data optimizer 33 determines that a migration operation is necessary, operation S250 may be performed. When the data optimizer 33 determines that a migration operation is not necessary, operation may be terminated.

In operation S250, the data optimizer 33 may select a storage system to which the first data is to be migrated. For example, the first data may be stored in the first storage system. For example, the data optimizer 33 may select a second storage system to which the first data is to be migrated from among the plurality of storage systems 22.

In operation S260, the data converter 34 may perform migration on the first data. For example, the data converter 34 may receive the second storage system suitable for the migration of the first data from the data storage adopter 33b. The data converter 34 may search for the first data in the plurality of storage systems 22. For example, the data converter 34 may migrate the first data from the first storage system where the first data is stored to the second storage system. For example, after the migration is completed, the data converter 34 may delete the first data in the first storage system.

In operation S270, the data access interface 21 may output the first data to the host 10. For example, the data converter 34 may search for the first data in the plurality of storage systems 22 and may provide the first data to the data access interface 21. The data access interface 21 may output the received first data to the host 10.

As described above, a user may define a schema with respect to the plurality of storage systems having various schemas in a customized manner. The user may manage a plurality of storage systems with a flexible schema structure by a user-defined schema.

In addition, the user may comprehensively perform mapping with respect to the custom defined schema. As comprehensive schema mapping is performed, the efficiency of data movement between a plurality of storage systems is improved.

Finally, dynamic adaptation to requirements between a plurality of storage systems is possible depending on user patterns. As comprehensive mapping is performed, movement between a plurality of storage systems becomes smooth, and data optimization strategies become easy by migrating data depending on usage patterns.

As used herein, the terms “interface”, “device” or “unit” refer to any combination of software, firmware, and/or hardware configured to provide the functionality described herein. For example, software may be implemented as a software package, code and/or set of instructions or instructions, and hardware, for example, may include hardwired circuitry, programmable circuitry, state machine circuitry, and/or a single or any combination, or assembly of firmware that stores instructions executed by programmable circuitry.

According to an embodiment of the present disclosure, a device that dynamically ensures interoperability between various storage systems is provided by comprehensively managing schema information and schema mapping information for data, and by migrating data depending on a user's usage pattern.

With the above configuration, a user may define a schema with respect to a plurality of storage systems having various schemas in a customized manner. The user may manage a plurality of storage systems with a flexible schema structure by a user-defined schema.

In addition, the user may comprehensively perform mapping with respect to the custom defined schema. As comprehensive schema mapping is performed, the efficiency of data movement between a plurality of storage systems is improved.

Accordingly, dynamic adaptation to requirements between a plurality of storage systems is possible depending on user patterns. As comprehensive mapping is performed, movement between a plurality of storage systems becomes smooth, and data optimization strategies become easy by migrating data depending on usage patterns.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A storage system management device comprising:
a plurality of storage systems configured to store data in different types;
a profile manager configured to manage first schema information including a structure of first data, an expression method, and a definition of relationships between data in the plurality of storage systems, and to manage first schema mapping information including mapping information associated with correlations between a plurality of pieces of schema information of the first data;
a metadatabase configured to store the first schema information and the first schema mapping information; and
a data converter configured to perform an operation of accessing the first data in the plurality of storage systems, and
wherein the storage system management device is configured to manage schema information and schema mapping information associated with the data of the plurality of storage systems.

2. The storage system management device of claim 1, further comprising:
a data access interface configured to determine whether a host has an access authority with respect to an access request to the plurality of storage systems,
to determine whether the access request is in a correct format, and
to relay communication between the plurality of storage systems and the host.

3. The storage system management device of claim 1, wherein the profile manager is configured to generate second schema information including definitions of new structures, expression methods, and relationships between data for the first data based on a profile generation request from the host, and to store the second schema information in the metadatabase.

4. The storage system management device of claim 3, wherein the profile manager updates the first schema mapping information to include information associated with correlations between the first schema information and the second schema information.

5. The storage system management device of claim 1, wherein the metadatabase stores first usage pattern related information including an access time, a task type, and a task frequency of a host, and
stores second usage pattern related information including a time of a first data access request, a task type, and a task frequency, based on the first data access request of the host,
wherein the storage system management device further includes a data optimizer, and
wherein the data optimizer is configured to:
analyze the first usage pattern related information and the second usage pattern related information to determine whether a migration operation of the first data is performed, and
select a first storage system among the plurality of storage systems to which the first data is to be migrated, based on the result of determining whether the migration operation is performed.

6. The storage system management device of claim 5, wherein the data optimizer is configured to select the first storage system based on type information including performance information, capacity information, and cost information of the plurality of storage systems.

7. The storage system management device of claim 5, wherein the metadatabase includes a relational database and a monitoring database,
wherein the relational database is configured to store the first schema information and the first schema mapping information, and
wherein the monitoring database is configured to store the first usage pattern related information and the second usage pattern related information.

8. The storage system management device of claim 5, wherein the data converter is configured to migrate the first data to the first storage system.

9. A storage system management method of a storage system management device including a plurality of storage systems, a profile manager, and a metadatabase, the storage system management method comprising:
wherein first schema information includes a structure of first data, an expression method, and a definition of relationships between data in the plurality of storage systems, and
wherein first schema mapping information stored in the metadatabase includes mapping information associated with correlations between a plurality of pieces of schema information of the first data, and
receiving, by the profile manager, second schema information including a new structure of the first data, an expression method, and a definition of relationships between data, based on a profile generation request of the first data from a host;
storing, by the profile manager, the second schema information in the metadatabase; and
updating, by the profile manager, the first schema mapping information to include information associated with correlations between the first schema information and the second schema information.

10. The storage system management method of claim 9, further comprising:
a validation determination operation, by the profile manager, of determining an access authority of the host and determining whether the profile generation request is in a correct format, with respect to the profile generation request from the host, and
wherein the profile manager stores the second schema information in response to determining that the profile generation request is valid.

11. The storage system management method of claim 9, wherein the storage system management device further includes a data optimizer,
wherein the metadatabase stores first usage pattern related information including an access time, a task type, and a task frequency of the host, and
wherein the storage system management method further includes:
generating, by the profile manager, second usage pattern related information including a time of the profile generation request of the first data, a task type of the first data, and a task frequency of the first data, based on the profile generation request of the first data of the host, and storing the second usage pattern related information in the metadatabase; and
analyzing, by the data optimizer, the first usage pattern related information and the second usage pattern related information to determine whether a migration operation of the first data is performed.

12. The storage system management method of claim 11, wherein the metadatabase includes a relational database and a monitoring database,
wherein the relational database is configured to store the first schema information and the first schema mapping information, and
wherein the monitoring database is configured to store the first usage pattern related information and the second usage pattern related information.

13. The storage system management method of claim 11, wherein the storage system management device further includes a data converter, and
wherein the storage system management method further includes:
selecting, by the data optimizer, a first storage system among the plurality of storage systems to which the first data is to be migrated, in response to determining that the migration operation is necessary; and
migrating, by the data converter, the first data to the first storage system.

14. The storage system management method of claim 13, wherein the data optimizer is configured to select the first storage system based on type information including performance information, capacity information, and cost information of the plurality of storage systems.

15. A storage system access method of a storage system management device including a plurality of storage systems, a metadatabase, a data optimizer, a data converter, and a data access interface, the storage system access method comprising:
receiving, by the data access interface, a first data access request within the plurality of storage systems from a host;
wherein the metadatabase stores first usage pattern related information including an access time, a task type, and a task frequency of the host, and
generating, by the data access interface, second usage pattern related information including a time of the first data access request, a task type, and a task frequency, based on the first data access request, and storing the second usage pattern related information in the metadatabase;
analyzing, by the data optimizer, the first usage pattern related information and the second usage pattern related information to determine whether a migration operation of the first data is performed;
selecting, by the data optimizer, a first storage system among the plurality of storage systems to which the first data is to be migrated, in response to determining that the migration operation is necessary; and
migrating, by the data converter, the first data to the first storage system; and
outputting, by the data converter, the first data to the host.

16. The storage system access method of claim 15, wherein the data optimizer is configured to select the first storage system based on type information including performance information, capacity information, and cost information of the plurality of storage systems.

17. The storage system access method of claim 15, further comprising:
in response to determining that the migration operation is not necessary, outputting, by the data access interface, the first data to the host.

18. The storage system access method of claim 15, further comprising:
a validation determination operation, by the data access interface, of determining an access authority of the host and determining whether the access request is in a correct format, with respect to the first data access request from the host, and
wherein the data optimizer stores the second usage pattern related information in the metadatabase, in response to determining that the first data access request is valid.
